(19) United States
(12) Patent Application Publication
(10) Pub. No.: US 2004/0266406 A1
(43) Pub. Date: Dec. 30, 2004

(54) Wireless customer segmentation and marketing process

(76) Inventor: Rajasekhar Venkat Meda, Pickerington, OH (US)

Correspondence Address: GREENBERG TRAURIG, LLP, 885 Third Avenue, New York, NY, 10022, US

(21) Appl. No.: 10/607,622

(22) Filed: Jun. 27, 2003

(51) Int. Cl. H04Q 7/20

(52) U.S. Cl. 455/414.1; 455/432.3; 455/433; 705/14

(57) ABSTRACT

A method is provided in which subscribers of a communication system who travel outside their home areas can receive marketing and/or advertising information while their cellular phones are idle but activated. The content or subject matter of the promotional information depends on the current location of the subscriber and the history of that subscriber in that location.

### BACKGROUND OF THE INVENTION

1. Field of the Invention

The present invention relates to wireless communication systems.

2. Description of the Related Art

The cellular phone has become ubiquitous in our society. As time passes cellular phones and the wireless communication systems with which such phones interface are obtaining more and more features. As the wireless communication technologies enter into what is called the third generation (i.e., 3G) cellular phones are able to receive not only voice signals and low speed data signals, but also video signals accompanied by voice, graphics signals, still pictures, high speed data or any combination of these types of signals. The cellular phones are now designed with relatively wider screens, new accessories such as cameras and generally more features than prior cellular phone designs. Most users of cellular phones probably do not realize that whenever they activate their phones (i.e., switch on the phone) various signals are being received by the phones from system equipment and moreover the phones are transmitting information to the system. As is well known a cellular phone is one type of user equipment with which a wireless communication system communicates. Generally user equipment is referred to as a mobile which comprise cellular phones, pagers, wireless computers, wireless text messaging devices and many other types of wireless user equipment typically owned by a subscriber. The equipment with which the mobiles communicate is usually a base station. The base station comprises various transmit, receive and processing circuitry that receive signals from cellular phones (or other type of mobile) and transmit signals to cellular phones located within a defined geographical area usually referred to as a cell. The base station also receives and transmits information to other equipment of the communication system that help to control, operate and maintain the entire communication system. These other equipment are sometimes referred to as backbone equipment with which the cellular phones indirectly interface. The base station acts as a “middle man” between the backbone equipment and a subscriber's cellular phone. The phones, while in idle or during an idle period (i.e., phone is turned on but is not being used by subscriber) is receiving information (hereinafter “idle information”) from the base station or backbone equipment or both.

The idle information comprise various background processing information necessary to determine such parameters as the amount of power at which the phone is transmitting signals, the i.d. of the cellular phone, synchronization signals, time of day signals and authorization signals permitting the phone access to the communication system. In general, the idle information comprises all information necessary to grant the subscriber authorization to use the system and information about the status of the subscriber such as the subscriber's physical location.

The idle information is transmitted over communication channels commonly referred to as signaling channels. The signaling channels are communication channels used by the communication system to control, operate and otherwise maintain the communication system. Subscribers of the communication system transmit and/or receive information over traffic channels. In third generation systems, the communication channels—including the signaling channels—have relatively larger bandwidths. The bandwidth of a channel can be defined in terms of the amount of information that can be transmitted over such channel at any particular time. Even though larger bandwidth signaling channels are available in 3G systems, relatively more signaling information is transmitted over these channels to operate, control and otherwise maintain these systems. However, there are times when a significant portion of the bandwidth of these channels is not being used.

With signaling channels, the system is able to communicate with a subscriber's cellular phone as long as the phone has been authorized by the system and is activated by the user. Moreover, the system has the ability to determine the location of an active cellular phone; this is done with the use of system databases known as the Home Location Register (HLR) and the Visitor Location Register (VLR). A subscriber typically obtains wireless cellular service for a defined geographic area sometimes called a Home area. The subscriber can still be served when located outside of the Home area, but typically will be charged a relatively higher billing rate. A subscriber is said to be “roaming” when the subscriber's cellular phone is activated while in area outside of the Home area. It should be noted that a subscriber may be in an area outside the Home area and still not be considered to be roaming; the subscriber may have obtained a service that comprises several Home areas.

Each cellular phone being served (i.e., authorized) by the system is given a unique identification (i.d.) number. All i.d. numbers are stored in the HLR database. The HLR may contain i.d. numbers of phones having obtained service for one or more Home areas. A Home area may comprise one or more cells where each cell is being served by a base station. When a subscriber activates an authorized cellular phone, among other things, the phone transmits its i.d. number to the system upon receiving a query from the system. The system then determines whether the subscriber is in a Home area by determining whether the received i.d. number is in the HLR of the area within which the subscriber is currently located. If the i.d. number is in the HLR, the subscriber is deemed to be in a Home area and the subscriber's current location is known. If the i.d. number is not in the HLR, the system stores the i.d. number in the area's VLR indicating that the authorized subscriber is not in a Home area. At this point, depending on the system configuration and the type of service being provided to the subscriber, the subscriber may be deemed to be roaming. Whether the received i.d. number is stored in an HLR or a VLR, the system is able to determine the current location of an activated phone and thus is aware of the current location of a subscriber in possession of the activated cellular phone. Therefore, as a subscriber travels throughout a system, the system can detect to a certain accuracy the physical location of the subscriber. The ability of the system to determine the physical location of a subscriber authorized to use the system and the system's ability to communicate with the subscriber's cellular phone in idle mode represent resources that may be exploited by the operator of such a communication system.

### SUMMARY OF THE INVENTION

The present invention provides a method for communication system equipment to transmit certain messages to mobiles of subscribers of the system for the purpose of marketing products and/or services to the subscribers. Depending on the location of the mobile in a communication system, the system determines whether the subscriber is visiting and out of its Home area. If the system determines that the subscriber is a visitor, then depending on the type of visitor the subscriber is determined to be, certain types of marketing and/or advertising information are transmitted to the subscriber. Thus, the system has designated the subscriber to receive marketing and/or advertising information.

The advertising and marketing information can be in the form of video (with or without sound), audio, graphics or text. The information may be sent over traffic channels and/or signaling channels. Preferably, the subscriber will receive the information during an idle period.

In particular the method of the present invention first determines whether the cellular phone of the subscriber has its identification number stored in a Visitor Location Register (VLR) or a Home Location Register (HLR). Depending on the location of the i.d. number, the method of the present invention is able to determine whether the subscriber is a visitor or not. If the subscriber is deemed to be a visitor, then the method of the present invention further determines the type of visitor the subscriber has been deemed to be. Depending on the type of visitor the subscriber is categorized as and the physical location of the subscriber, the system of the present invention can market goods and/or services to the subscriber by transmitting advertising and/or marketing messages to the subscriber's cellular phone.

### BRIEF DESCRIPTION OF THE DRAWINGS

FIG. 1 is a flow chart representing the method of the present invention.

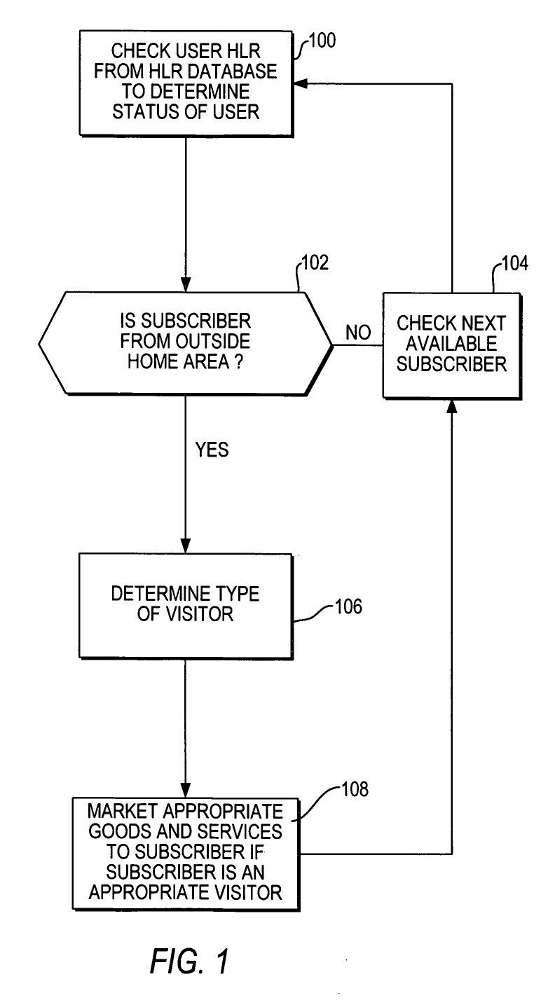

### DETAILED DESCRIPTION

The present invention provides a method for communication system equipment to transmit certain messages to mobiles of subscribers of the system for the purpose of marketing products and/or services to the subscribers. Depending on the location of the mobile in a communication system, the system determines whether the subscriber is visiting and out of its Home area. If the system determines that the subscriber is a visitor, then depending on the type of visitor the subscriber is determined to be, certain types of marketing and/or advertising information are transmitted to the subscriber. Thus, the system has designated the subscriber to receive marketing and/or advertising information. The advertising and marketing information can be in the form of video (with or without sound), audio, graphics or text. The information may be sent over traffic channels and/or signaling channels. Preferably, the subscriber will receive the information during an idle period, i.e., a period of time during which the subscriber is not transmitting and/or receiving information or is not engaged in communications with another subscriber.

In particular the method of the present invention first determines whether the cellular phone of the subscriber has its identification number stored in a Visitor Location Register (VLR) or a Home Location Register (HLR). Depending on the location of the i.d. number, the method of the present invention is able to determine whether the subscriber is a visitor or not. If the subscriber is deemed to be a visitor, then the method of the present invention further determines the type of visitor the subscriber has been deemed to be. Depending on the type of visitor the subscriber is categorized as and the physical location of the subscriber, the system of the present invention can market goods and/or services to the subscriber by transmitting advertising and/or marketing messages to the subscriber's cellular phone.

It is understood that a mobile is usually co-located with a subscriber especially when the mobile is being used by the subscriber. Therefore, hereinafter, the term ‘subscriber’ may be used interchangeably with the term ‘mobile.’ The marketing and/or advertising information will be arranged in a format and transmitted as per a protocol being followed by the communication system. A protocol is a set of rules that dictate how communication is to be initiated, maintained and terminated by a communication system. The protocol also dictates the particular arrangement (i.e., the format) of information to be conveyed (i.e., transmitted and/or received) over a communication system.

The method of the present invention provides a technique that markets goods and/or services directly to mobile equipment of a subscriber to a wireless cellular communication system. In step 100, the method of the present invention checks to see whether a subscriber's identification number is located in a VLR or HLR. The user status is check, i.e., the method of the present invention checks to see if a user is subscriber. If a user has subscribed to the communication system, his cellular phone (or other mobile equipment) has an identification number. For many communication systems an activated phone transmits its identification number to the base station serving that particular subscriber. The i.d. number is stored either in an HLR or a VLR by the system. The method of the present invention, which may reside as software in processing equipment at the base station or may reside as software in backbone equipment will obtain the identification number of a cellular phone currently being served by the system. The method of the present invention can also be distributed throughout the system and thus reside throughout various equipment in the communication system. The method of the present invention will then use the VLR and HLR databases for the area within which the subscriber is currently located to determine the status of the subscriber and decide whether to designate the user as a subscriber who can receive promotional material. It will be understood that the method of the present invention may use information in addition to VLR information to designate subscribers who can receive marketing and/or advertising information. Further, the method of the present invention can use information other than VLR information to designated subscribers who can receive marketing and/or advertising information. For example, the use of a database of a business as discussed below in one such technique used to designate subscribers.

In particular, in step 102, the method of the present will determine whether the obtained identification number is for a visiting subscriber. The obtained identification number is compared to numbers stored in an HLR and a VLR of that area. If the i.d. number matches a number stored in an HLR, the subscriber is not a visitor and the method of the present invention moves to step 104 where it waits to check the next available subscriber that has entered the area with an activated mobile. If, however, the i.d. number matches a number stored in the VLR, then the subscriber is deemed to be a visitor and the method of the present invention moves to step 106. The visitor may be, for example, a business traveler who may or may not have visited the area before. The visitor may be visiting family members or may be on vacation for several days. While in the area, the visitor may need services such as car rental, restaurants, hotels, entertainment. Further, the visitor may be interested in buying various goods such as clothing or any sundry items found in a local department store or shopping mall. However, the visitor may not be a true visitor because there are many subscribers who subscribe to a particular service for a particular home area , but for whatever reason spend most of their time outside their home area.

In step 106, the method of the present invention first tries to determine whether the subscriber is a true visitor and if so, categorize the subscriber into a particular type of visitor. The categories for visitors may be defined by the operator or owner of the communication who is using the method of the present invention. One way to determine whether the subscriber is a true visitor is to peruse that subscriber's history in the particular VLR in which the subscriber's i.d. was stored. As explained above a subscriber with a history of many appearances in a VLR may in fact reside or spend much time in that area. In such a case, that subscriber may be deemed not to be a visitor by the method of the present invention. As with many databases, the VLR may contain archival information documenting a subscriber's history for a period of time such as a month, a week, or several days. Depending on the category being used by the method of the present invention, a subscriber having a history of a week in a VLR may be deemed to be not a true visitor. In other cases, a subscriber will be deemed not to be a true visitor if that subscriber has a history in the VLR that spans several months. Thus, the length of contiguous time that a subscriber's i.d. has appeared in a VLR can be one factor that determines whether the visitor is a true visitor. Therefore, a true visitor can be defined as a subscriber that has little or no history in the VLR. Conversely, the true visitor may have a long history in the VLR but the manner in which history occurs may indicate that the particular subscriber is a true visitor. For example, a subscriber may have a VLR history that occurs periodically for months (e.g., 3 visits each month for the last 10 months) or even years representing the subscriber's visit to a business concern or a family member. Thus, even though that subscriber has a long history in the VLR, circumstances are such that the subscriber can be properly considered to be a true visitor. In sum, step 106 determines if the subscriber is an appropriate visitor meaning that the subscriber is the type of visitor to whom goods and services may be marketed.

In step 108, appropriate goods and services are marketed to the subscriber if that subscriber is found to be a type of visitor who is relatively new to the area or who has spent some time in the area in the past. A true visitor is most likely not someone who has spent a relatively long contiguous period of time in the area. If the visitor is not a true visitor, the method of the present invention moves to step 104 and waits for next available subscriber that has entered the area. Various video, graphic, voice, text and other types of advertising, marketing promotional messages for businesses in the area can be transmitted to the subscriber. If the subscriber is engaged in conversation or is otherwise using the mobile (e.g., cell phone, wireless laptop) the transmission of the marketing or advertisement messages are postponed by the method of the present invention until the cellular device is in the idle mode.

Depending on the type of visitor the subscriber is deemed to be, particular types of marketing messages can be transmitted to that subscriber. For example, the subscriber may be a returning visitor who has used the services or bought goods from local businesses and merchants in prior occasions as a result of the advertisement or marketing of the method of the present invention. The method of the present invention may work in concert with local businesses to develop buying histories of recurring visitors to increase the loyalty of certain subscribers and help businesses tailor their services and goods to better fulfill the desires of their customers. The content of the marketing and/or advertisement message sent to a true visitor may be based on contents of databases other than the HLR and VLR. These other databases can be in communication with the communication system. For example, buying histories of customers or a list of customers stored in a database of a business can be provided to the communication system to assist the system to market and/or advertise the appropriate goods and services to the subscribers. The method of the present invention may represent an extra source of revenue for the system operator because the operator may be able to enter into an agreement with various businesses to share in the profits from the extra business generated due to the wireless marketing and/or advertisement.

We claim:

1. A method of communicating in a wireless communication system having a plurality of mobiles, the method comprising the step of:
designating marketing and/or advertisement information based on information stored in a database; and
transmitting the marketing and/or advertising information.

2. The method of claim 1 where the step of transmitting marketing and/or advertising information comprises:
determining whether a received identification number is stored in a VLR; and
designating a mobile based on a history of the mobile's identification number stored in a VLR database.

3. The method of claim 1 where the system designates marketing and/or advertising information for a mobile based on the mobile's current location.

4. The method of claim 1 where the marketing and/or advertising information is transmitted over a signaling channel of the communication system.

5. The method of claim 1 where the marketing and/or advertisement information is arranged in a format and transmitted as per a protocol being followed by the communication system.

6. The method of claim 1 where the transmission of the marketing and/or advertising information is postponed until a mobile whose identification number located in an HLR of VLR was use to designate the marketing and/or advertising information is in idle mode.

7. The method of claim 1 where the transmitted marketing and/or advertisement information is based on information stored in a VLR and one or more databases in communication with the system.

8. The method of claim 1 where at least one of the mobiles is a cellular phone or a wireless computer.

9. A method of communicating in a wireless communication system, the method comprising the steps of:
transmitting an identification number;
receiving marketing and/or advertising information as designated by the identification number.

10. The method of claim 9 where the system designates marketing and/or advertising information based for a mobile of the communication system based on the mobile's current location.

11. The method of claim 9 where the marketing and/or advertising information is arranged in a format and transmitted as per a protocol being followed by the communication system.

12. The method of claim 9 where the reception of the marketing and/or advertising information is postponed until a mobile whose identification number located in a VLR was used to designated the marketing and/or advertising information is in idle mode.

13. The method of claim 9 were the transmitted marketing and/or advertising information is based on information stored in a VLR and one or more databases in communication with the system.

14. The method of claim 9 where the marketing and/or advertising information is transmitted by a cellular phone or a wireless computer.
